(19) United States
(12) Patent Application Publication
(10) Pub. No.: US 2018/0264889 A1
(43) Pub. Date: Sep. 20, 2018

(54) PNEUMATIC TIRE

(71) Applicant: Toyo Tire & Rubber Co., Ltd., Itami-shi (JP)

(72) Inventor: Tsunetaka Nakamata, Itami-shi (JP)

(73) Assignee: Toyo Tire & Rubber Co., Ltd., Itami-shi (JP)

(21) Appl. No.: 15/918,484

(22) Filed: Mar. 12, 2018

(30) Foreign Application Priority Data
Mar. 16, 2017 (JP) 2017-051701

(51) Int. Cl. B60C 11/12

(52) U.S. Cl. CPC B60C 11/124; B60C 11/1263; B60C 11/125

(57) ABSTRACT

In a pneumatic tire according to an embodiment, a plurality of blocks are arranged in a tire circumferential direction in a land portion partitioned by a main groove extending in the tire circumferential direction, a depth of a transverse groove between the blocks adjacent in the tire circumferential direction ranges from 20% to 35%, inclusive, of a depth of the main groove, and a sipe narrower in width than the transverse groove is disposed on a bottom portion side of the transverse groove.

### CROSS-REFERENCE TO RELATED APPLICATION

The disclosure of Japanese Patent Application No. 2017-051701 filed on Mar. 16, 2017 including the specification, drawings and abstract is incorporated herein by reference in its entirety.

### TECHNICAL FIELD

The present invention relates to a pneumatic tire.

### BACKGROUND ART

A pneumatic tire that has a block row in a tread is likely to undergo heel-and-toe wear as one of the treading side and the kicking side of a block undergoes more wear than the other. In this regard, various structures for heel-and-toe wear prevention have been proposed in the related art. In the pneumatic tire that is disclosed in JP-A-2011-183952, for example, a narrow portion on a tread surface side and a wide portion on the inner side in a tire radial direction are disposed in a sipe formed in a block. The pneumatic tire that is disclosed in JP-A-2011-183952 is configured such that the shape of the wide portion changes from the end portion of the sipe on one side toward the end portion of the sipe on the other side and the wide portion entails a change in angle during appearance on the tread surface resulting from the progress of wear.

The rigidity of the block is related to heel-and-toe wear. Various structures for ensuring the rigidity have been proposed in the related art as well. According to JP-A-2009-528946, for example, a locking region to reduce the width of a sipe is disposed in the sipe so that the rigidity is ensured.

### SUMMARY OF THE INVENTION

The present invention has been made in view of such circumstances, and an object thereof is to provide a novel pneumatic tire likely to undergo no heel-and-toe wear.

In a pneumatic tire according to an embodiment, a plurality of blocks are arranged in a tire circumferential direction in a land portion partitioned by a main groove extending in the tire circumferential direction, a depth of a transverse groove between the blocks adjacent in the tire circumferential direction ranges from 20% to 35%, inclusive, of a depth of the main groove, and a sipe narrower in width than the transverse groove is disposed on a bottom portion side of the transverse groove.

In the pneumatic tire according to the embodiment, the depth of the transverse groove is within a predetermined range and the sipe narrower in width than the transverse groove is disposed on the bottom portion side of the transverse groove, and thus the rigidity of the block increases and the block is likely to undergo no heel-and-toe wear.

### BRIEF DESCRIPTION OF THE DRAWINGS

FIG. 1 is a diagram illustrating a tread pattern of a pneumatic tire according to an embodiment.

FIG. 2 is a cross-sectional view taken along line A-A of FIG. 1.

FIG. 3 is a cross-sectional view taken along line B-B of FIG. 1.

FIG. 4 is a cross-sectional view taken along line C-C of FIG. 1.

FIG. 5 is a diagram illustrating a tread pattern according to a modification example.

FIG. 6 is a diagram illustrating a modification example of the cross-sectional view taken along line A-A of FIG. 1.

FIG. 7(a) to FIG. 7(f) each is a cross-sectional view of transverse grooves and sipes according to examples and comparative examples in a tire width direction. FIG. 7(a) is a diagram illustrating Comparative Example 1. FIG. 7(b) is a diagram illustrating Comparative Example 2. FIG. 7(c) is a diagram illustrating Example 1. FIG. 7(d) is a diagram illustrating Example 2. FIG. 7(e) is a diagram illustrating Example 3. FIG. 7(f) is a diagram illustrating Example 4.

### MODE FOR CARRYING OUT THE INVENTION

Hereinafter, a pneumatic tire according to an embodiment will be described with reference to accompanying drawings. In some cases, the drawings are shown in an exaggerated manner for descriptive purposes.

The pneumatic tire according to the embodiment is mounted on a vehicle such as a light truck. The structure of the pneumatic tire according to the embodiment is not limited except for a tread 10. Roughly, the pneumatic tire according to the embodiment has the following structure. Firstly, bead portions are disposed on both sides in a tire width direction, and a carcass is folded back from the inner side to the outer side in the tire width direction to wrap the bead portions and forms the skeleton of the pneumatic tire. A belt layer and a belt reinforcing layer are disposed on the outer side of the carcass in a tire radial direction, and the tread 10 that has a ground contact surface is disposed on the outer side in the tire radial direction. In addition, sidewalls are disposed on both sides of the carcass in the tire width direction. In addition to these members, a plurality of members are disposed to meet the requirements that relate to the function of the tire.

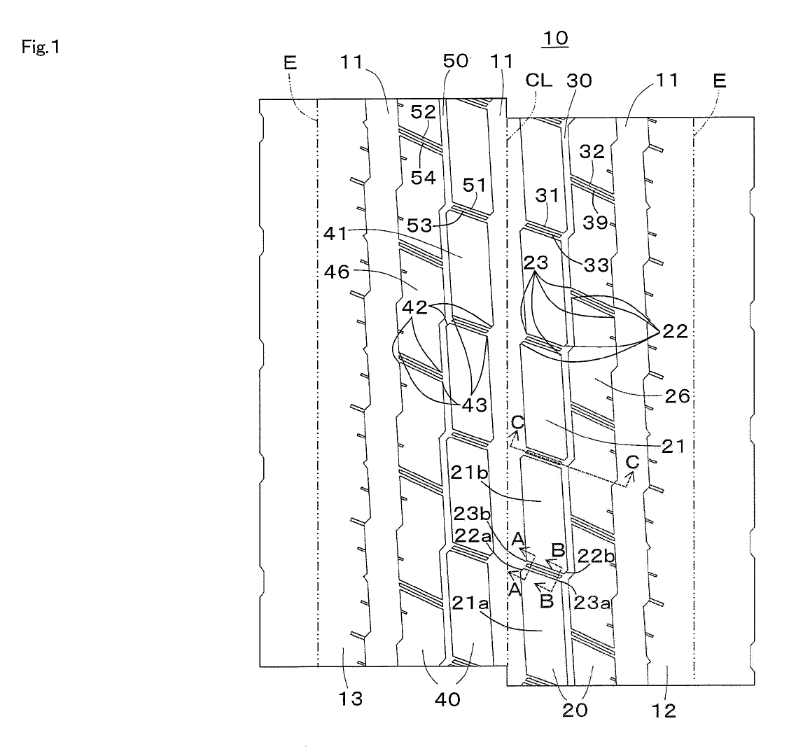

Three main grooves 11 extending in a tire circumferential direction are disposed in the tread 10 illustrated in FIG. 1. Partitioned by the main grooves 11, two left and right center land portions 20 and 40 close to a tire equator CL and two left and right shoulder land portions 12 and 13 are formed.

The center land portion 20 on the right side will be described below as an example.

A narrow groove 30 extending in the tire circumferential direction is disposed in the center land portion 20 on the right side. The narrow groove 30 is narrower in width than the main groove 11. The specific numerical value of the width of the narrow groove 30 ranges, for example, from 2 mm to 4 mm, inclusive. In addition, the depth of the narrow groove 30 ranges from 20% to 35%, inclusive, of the depth of the main groove 11. The center land portion 20 is divided into left and right by the narrow groove 30.

In the center land portion 20, a plurality of transverse grooves 31 and 32 are alternately disposed across the narrow groove 30. On the side that is closer to the tire equator CL than the narrow groove 30, a block row in which a plurality of center side blocks 21 are arranged in the tire circumferential direction is formed by the land portion being divided by the plurality of transverse grooves 31. On the side that is closer to a ground end E than the narrow groove 30, a block row in which a plurality of shoulder side blocks 26 are arranged in the tire circumferential direction is formed by the land portion being divided by the plurality of transverse grooves 32. The plurality of center side blocks 21 and the plurality of shoulder side blocks 26 are alternately disposed across the narrow groove 30.

The transverse grooves 31 and 32 extend obliquely with respect to the tire width direction. The center side block 21 is almost a parallelogram by the plurality of transverse grooves 31 extending in parallel, and the shoulder side block 26 is almost a parallelogram by the plurality of transverse grooves 32 extending in parallel. Since the transverse grooves 31 and 32 extend obliquely with respect to the tire width direction, in the center side block 21 and the shoulder side block 26, an acute corner portion 22 and an obtuse corner portion 23 are famed on both sides in the tire circumferential direction, respectively. In the two blocks that are adjacent in the tire circumferential direction, the acute corner portion 22 of one of the blocks faces the obtuse corner portion 23 of the other block across the transverse grooves 31 and 32.

The transverse grooves 31 and 32 are narrower in width than the main groove 11. The specific numerical value of the width of the transverse grooves 31 and 32 ranges, for example, from 2 mm to 4 mm, inclusive. In addition, the depth of the transverse grooves 31 and 32 ranges from 20% to 35%, inclusive, of the depth of the main groove 11.

As illustrated in FIGS. 1 to 3, a sipe 33 continuous from a bottom portion 36 of the transverse groove 31 is disposed on the bottom portion 36 side of the transverse groove 31. The sipe 33 is narrower in width than the transverse groove 31. The specific numerical value of the width of the sipe 33 ranges, for example, from 0.6 mm to 1.5 mm, inclusive. The total depth of the transverse groove 31 and the sipe 33, that is, the depth from an open end 37 of the transverse groove 31 toward the ground contact surface to a bottom portion 35 of the sipe 33 is shallower than the depth of the main groove 11.

As the sipe 33 becomes deeper, the sipe 33 is inclined in the direction in which the sipe 33 becomes farther from the acute corner portion 22 and penetrates the lower part of the obtuse corner portion 23 and twisted thereby. Specifically, referring to FIGS. 1 to 3, the sipe 33 between two center side blocks 21a and 21b adjacent in the tire circumferential direction is inclined in the direction in which the sipe 33 becomes farther from an acute corner portion 22a and penetrates the lower part of an obtuse corner portion 23b as the sipe 33 becomes deeper on the tire equator CL side. Furthermore, on the ground end E side, the sipe 33 is inclined in the direction in which the sipe 33 penetrates the lower part of an obtuse corner portion 23a and becomes farther from an acute corner portion 22b as the sipe 33 becomes deeper. An inclination angle θ of the sipe 33 continuously changes from the end portion of the sipe 33 on the tire equator CL side to the end portion of the sipe 33 on the ground end E side. As a result, the sipe 33 is twisted.

In other words, with respect to the center side block 21a on one side in the tire circumferential direction, the sipe 33 is inclined in the direction in which the sipe 33 becomes farther from the acute corner portion 22a as the sipe 33 becomes deeper on the acute corner portion 22a side and inclined in the direction in which the sipe 33 penetrates the lower part of the obtuse corner portion 23a as the sipe 33 becomes deeper on the obtuse corner portion 23a side. Inevitably as a result thereof, with respect to the center side block 21b on the other side in the tire circumferential direction, the sipe 33 is inclined in the direction in which the sipe 33 penetrates the lower part of the obtuse corner portion 23b as the sipe 33 becomes deeper on the obtuse corner portion 23b side and inclined in the direction in which the sipe 33 becomes farther from the acute corner portion 22b as the sipe 33 becomes deeper on the acute corner portion 22b side. The sipe 33 is twisted as the inclination angle θ of the sipe 33 continuously changes from the end portion of the sipe 33 on the tire equator CL side to the end portion of the sipe 33 on the ground end E side.

The inclination angle θ of the sipe 33 increases as the sipe 33 becomes closer to the acute corner portion 22 and the obtuse corner portion 23, that is, both sides in the tire width direction. Desirably, the magnitude of the inclination angle θ of the sipe 33 with respect to the direction perpendicular to the ground contact surface is 15° at most.

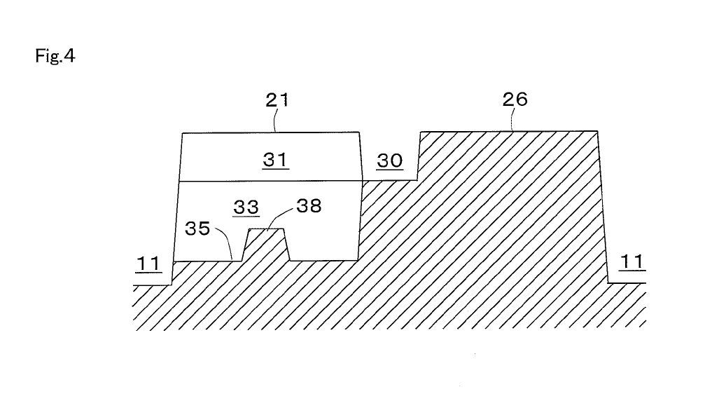

The depth of the sipe 33 may be partially shallow as well. The shallow part of the sipe 33 will be referred to as a tie bar 38. The tie bar 38 is formed throughout the sipe 33 in the width direction. As a result, the blocks 21 and 21 on both sides of the transverse groove 31 in the tire circumferential direction are connected. As illustrated in FIG. 4, the middle position in the sipe 33 is desirable as the position of the tie bar 38.

In FIG. 4, the end portion of the sipe 33 on the main groove 11 side is open to the main groove 11. In addition, the end portion of the sipe 33 on the shoulder side block 26 side is blocked within the range of the transverse groove 31 in the tire width direction. However, the end portion of the sipe 33 on the main groove 11 side may also be blocked within the range of the transverse groove 31 in the tire width direction without being open to the main groove 11.

Also, a sipe 39 that has the same characteristics as the sipe 33 on the bottom portion 36 side of the transverse groove 31 is disposed on the bottom portion side of the transverse groove 32 on the ground end E side.

In addition, the center land portion 40 on the left side has the same characteristics as the center land portion 20 on the right side. In other words, a narrow groove 50 extending in the tire circumferential direction is disposed in the center land portion 40 on the left side and two block rows composed of a center side block 41 and a shoulder side block 46 are formed with the narrow groove 50 interposed therebetween. Transverse grooves 51 and 52 extending obliquely with respect to the tire width direction are disposed between the blocks adjacent in the tire circumferential direction, and the depth of the transverse grooves 51 and 52 ranges from 20% to 35%, inclusive, of the depth of the main groove 11. Furthermore, sipes 53 and 54 that have the same width and depth as the sipe 33 are disposed on the bottom portion sides of the transverse grooves 51 and 52. The sipes 53 and 54 are inclined in the direction in which the sipes 53 and 54 become farther from an acute corner portion 42 as the sipes 53 and 54 become deeper on the acute corner portion 42 side of the block and inclined in the direction in which the sipes 53 and 54 penetrate the lower part of an obtuse corner portion 43 as the sipes 53 and 54 become deeper on the obtuse corner portion 43 side of the block and twisted thereby. Tie bars may be disposed in the sipes 53 and 54 as well.

The structure of the two shoulder land portions 12 and 13 is not limited to the structure that is illustrated in FIG. 1.

The pneumatic tire according to the present embodiment is likely to undergo no heel-and-toe wear. In existing pneumatic tires, transverse grooves between blocks are sufficiently deep and no sipe is present on the bottom portion sides of the transverse grooves. In the pneumatic tire according to the present embodiment, however, the depth of the transverse grooves 31, 32, 51, and 52 ranges from 20% to 35%, inclusive, of the depth of the main groove 11. In this manner, the sipes 33, 39, 53, and 54 narrower in width than the transverse grooves 31, 32, 51, and 52 are disposed on the bottom portion sides of the transverse grooves 31, 32, 51, and 52 instead of the transverse grooves 31, 32, 51, and 52 being shallow. As a result, the rigidity of the blocks on both sides of the transverse grooves 31, 32, 51, and 52 in the tire circumferential direction is higher than in existing pneumatic tires and the blocks are likely to undergo no heel-and-toe wear.

In general, an acute corner portion is more likely to undergo wear than an obtuse corner portion in a case where a block has the acute corner portion and the obtuse corner portion on both sides in a tire circumferential direction, respectively. In the present embodiment, however, the sipes 33, 39, 53, and 54 are inclined in the direction in which the sipes 33, 39, 53, and 54 become farther from the acute corner portions 22 and 42 as the sipes 33, 39, 53, and 54 become deeper on the acute corner portion 22 and 42 sides and inclined in the direction in which the sipes 33, 39, 53, and 54 penetrate the lower parts of the obtuse corner portions 23 and 43 as the sipes 33, 39, 53, and 54 become deeper on the obtuse corner portion 23 and 43 sides, and thus the rigidity in the vicinity of the acute corner portions 22 and 42 increases and the rigidity in the vicinity of the obtuse corner portions 23 and 43 decreases. As a result, the vicinity of the acute corner portions 22 and 42 likely to undergo wear before becomes likely to undergo no wear in a relative manner and the blocks are likely to undergo no heel-and-toe wear.

In addition, the rigidity of the blocks in the vicinity of the tie bar increases by the sipes 33, 39, 53, and 54 becoming partially shallow and the tie bar being formed. As a result, the blocks are likely to undergo no wear. Although the rigidity of the block tends to decrease especially in a case where the sipes 33, 39, 53, and 54 are long in the tire width direction, the decline in block rigidity is prevented by the tie bar.

The embodiment above is merely an example, and the scope of the present invention is not limited thereto. Various forms of change, substitution, omission, and so on can also be performed on the embodiment above within the scope of the present invention.

Firstly, the land portion in which the transverse groove and the sipe according to the present embodiment are disposed may include a plurality of blocks in which the acute corner portion is formed on one side in the tire width direction and the obtuse corner portion is formed on the other side in the tire width direction. The number of the block rows in which the blocks are formed in the land portion interposed between the two main grooves 11 is not limited to two as in the embodiment described above and may also be one or three or more.

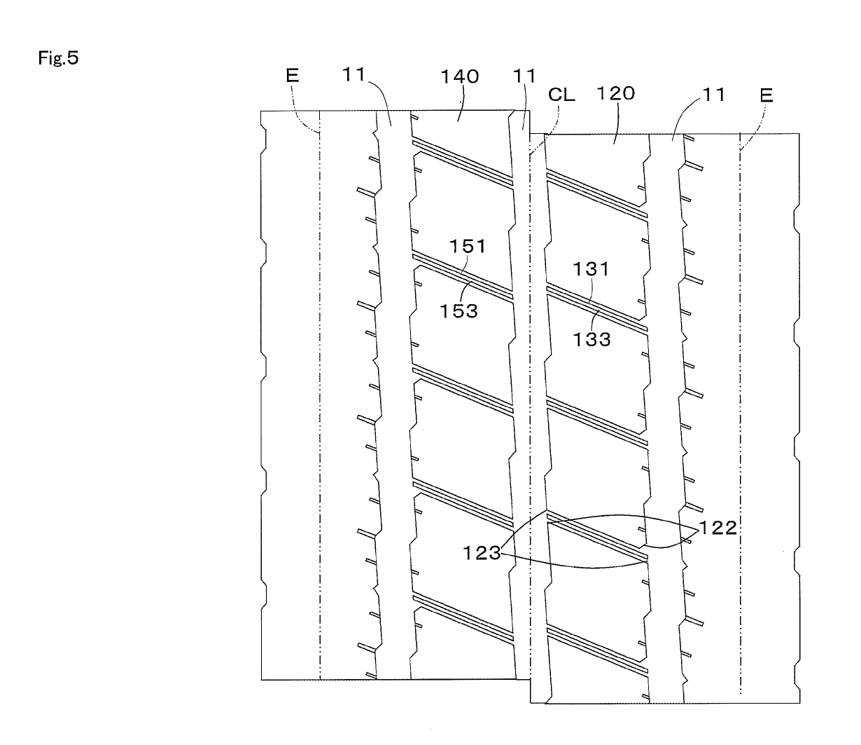

As an example, FIG. 5 illustrates a tread pattern in a case where the land portion interposed between the two main grooves 11 includes one block row. In the tread pattern illustrated in FIG. 5, a transverse groove 131 is disposed in a center land portion 120 on the right side and the depth of the transverse groove 131 ranges from 20% to 35%, inclusive, of the depth of the main groove 11. FurtheLmore, a sipe 133 that has the same width and depth as the sipe 33 according to the embodiment described above is disposed on the bottom portion side of the transverse groove 131. The sipe 133 is inclined in the direction in which the sipe 133 becomes farther from an acute corner portion 122 as the sipe 133 becomes deeper on the acute corner portion 122 side of the block and inclined in the direction in which the sipe 133 penetrates the lower part of an obtuse corner portion 123 as the sipe 133 becomes deeper on the obtuse corner portion 123 side of the block and twisted thereby. The transverse groove 131 and the sipe 133 are open to the main grooves 11 on both sides in the tire width direction. A tie bar may be disposed in the sipe 133 as well. A transverse groove 151 and a sipe 153 similar to the transverse groove 131 and the sipe 133 in the center land portion 120 on the right side are disposed in a center land portion 140 on the left side. Even in a case where one block row is interposed between the two main grooves 11 as described above, the rigidity of the block increases and the block is likely to undergo no heel-and-toe wear as in the embodiment described above.

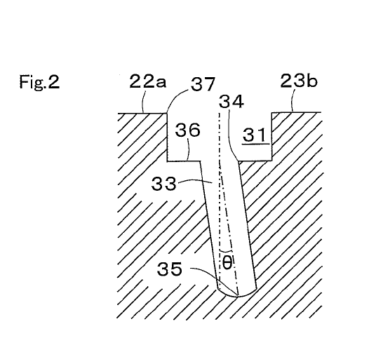

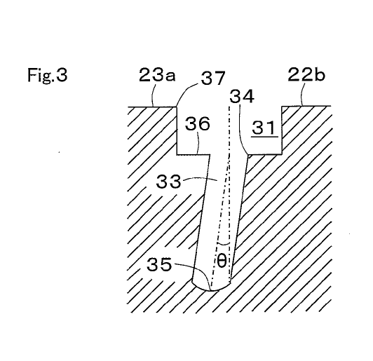

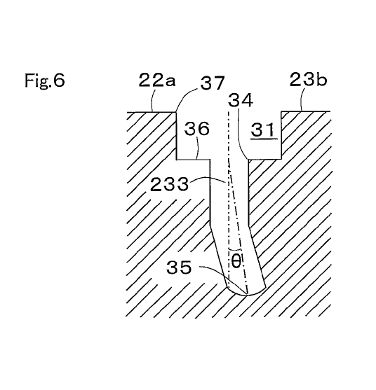

In FIGS. 2 and 3 of the embodiment described above, the sipe 33 extends straight from an open end 34 toward the transverse groove 31 to the bottom portion 35. However, as illustrated in FIG. 6, a sipe 233 may also extend in the direction perpendicular to the ground contact surface by a certain distance from the open end 34 toward the transverse groove 31, be bent at the position at the certain distance from the open end 34, and be inclined at the part from the position at the certain distance from the open end 34 to the bottom portion 35. In a case where the sipe 233 is bent at the position at the certain distance from the open end 34 as illustrated in FIG. 6, the part from the bending position to the bottom portion 35 is inclined to become farther from the acute corner portion 22 of the block 21 and become closer to the obtuse corner portion 23 of the block 21.

In a case where the sipe 233 is bent at the position at the certain distance from the open end 34 as illustrated in FIG. 6, the inclination angle θ is the angle that is formed by a line connecting the open end 34 of the sipe 233 and the bottom portion 35 of the sipe 233 to each other and a line perpendicular to the ground contact surface. Desirably, the magnitude of the inclination angle θ is 15° at most as in the embodiment described above. In addition, in a case where the sipe 233 is bent at the position at the certain distance from the open end 34 as illustrated in FIG. 6, the depth of the sipe 233 may be partially shallow and a tie bar may be formed in the middle position in the sipe 233 or the like as well.

In the embodiment described above, no sipe is disposed on the bottom portion sides of the narrow grooves 30 and 50 extending in the tire circumferential direction. However, a sipe continuous from the bottom portions of the narrow grooves 30 and 50 may be disposed on the bottom portion sides of the narrow grooves 30 and 50 as well. This sipe is narrower in width than the narrow grooves 30 and 50. In addition, the total depth of the narrow grooves 30 and 50 and the sipe is shallower than the depth of the main groove 11. This sipe may be inclined in the direction in which the sipe becomes farther from the acute corner portions 22 and 42 as the sipe becomes deeper on the acute corner portion 22 and 42 sides of the block and inclined in the direction in which the sipe penetrates the lower parts of the obtuse corner portions 23 and 43 as the sipe becomes deeper on the obtuse corner portion 23 and 43 sides and twisted thereby. For the rigidity of the block to be ensured, the sipe on the bottom portion sides of the narrow grooves 30 and 50 is not connected to the sipe on the bottom portion sides of the transverse grooves 31, 32, 51, and 52.

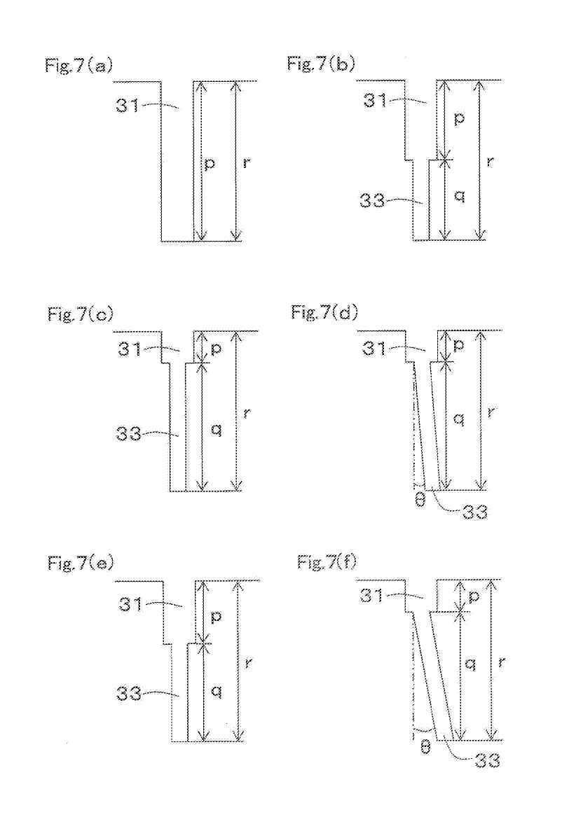

The uneven wear resistance and extractability in vulcanization molding of pneumatic tires according to the examples and comparative examples shown in Table 1 have been evaluated. The same block row as in FIG. 1 of the embodiment described above is formed in the treads of the pneumatic tires used in the evaluation. Although a transverse groove is indicated by sign 31 and a sipe is indicated by sign 33 for convenience in the following description and FIGS. 7(a) to 7(e), the characteristics shown in the following description and FIGS. 7(a) to 7(e) are common to every transverse groove (transverse grooves 31, 32, 51, and 52 in FIG. 1) and sipe (sipes 33, 39, 53, and 54 in FIG. 1) of one pneumatic tire.

As shown in Table 1 and FIGS. 7(a) to 7(e), the presence or absence of the sipe 33 and the sectional shapes of the transverse groove 31 and the sipe 33 are different in the examples and the comparative examples. The overall depth r in Table 1 is the total depth of a transverse groove depth p and a sipe depth q. The sipe 33 according to Examples 2 and 4 is inclined in the direction in which the sipe 33 becomes farther from the acute corner portion as the sipe 33 becomes deeper on the acute corner portion side of the block and inclined in the direction in which the sipe 33 penetrates the lower part of the obtuse corner portion as the sipe 33 becomes deeper on the obtuse corner portion side of the block and twisted thereby. The sipe maximum inclination angle θ in Table 1 is the magnitude of the inclination angle of the sipe 33 with respect to the direction perpendicular to the ground contact surface at the position where the sipe 33 is most inclined. The width of the transverse groove 31 and the main groove depth are the same in every example and comparative example, and the width of the transverse groove 31 is 3 mm and the main groove depth is 14 mm.

In the uneven wear resistance evaluation, the tire size is 205/85R16, the mounting rim size is 16×5.50, and the internal pressure is 600 kPa. After the pneumatic tire as an evaluation object was mounted on a vehicle, the vehicle was allowed to travel 12,000 km with a load of 12.6 kN. After the traveling, the wear difference between the treading side and the kicking side of the center side block was measured. Then, the average value of the wear differences of two pneumatic tires was obtained and the average value has been turned into an index. The index of Comparative Example 1 is 100, and the index decreases as the wear difference decreases.

In the extractability evaluation, the pneumatic tire was removed from a mold after vulcanization molding of the pneumatic tire was completed, and then the presence or absence of a defect of the rubber in the vicinity of the sipe 33 was conformed. Defect occurrence rates have been obtained by this conformation being performed on a plurality of pneumatic tires. The occurrence rate is the extractability.

The results of the evaluations are as shown in Table 1. It has been confirmed that the uneven wear resistance is improved when the sipe 33 is present on the bottom portion side of the transverse groove 31. In addition, it has been confirmed that the uneven wear resistance is further improved when the sipe 33 is twisted as described above. Furthermore, it has been conformed that the extractability does not extremely deteriorate even when the sipe 33 on the bottom portion side of the transverse groove 31 is twisted and the extractability is satisfactory insofar as the sipe maximum inclination angle θ is 15 degrees or less.

TABLE 1

| | | Comparative | Comparative | Example | Example | Example | Example |
|---|---|---|---|---|---|---|---|
| | | Example 1 | Example 2 | 1 | 2 | 3 | 4 |
| Characteristics | Drawing | FIG. 7 (a) | FIG. 7 (b) | FIG. 7 (c) | FIG. 7 (d) | FIG. 7 (e) | FIG. 7 (f) |
| | Presence or absence of sipe | Absent | Present | Present | Present | Present | Present |
| | Narrow groove depth p | 12.0 | 6.0 | 2.4 | 2.4 | 4.2 | 2.4 |
| | (mm) | | | | | | |
| | Sipe depth q (mm) | 0.0 | 6.0 | 9.6 | 9.6 | 7.8 | 9.6 |
| | Overall depth r (mm) | 12.0 | 12.0 | 12.0 | 12.0 | 12.0 | 12.0 |
| | Ratio of sipe depth q to | 0 | 50 | 80 | 80 | 65 | 80 |
| | overall depth r (%) | | | | | | |
| | Sipe maximum inclination | 0 | 0 | 0 | 15 | 0 | 20 |
| | angle θ (°) | | | | | | |
| Evaluation | Uneven wear resistance | 100 | 70 | 45 | 30 | 55 | 25 |
| | Extractability (%) | 0.0 | 0.0 | 0.0 | 0.5 | 0.0 | 2.5 |

1. A pneumatic tire,
wherein a plurality of blocks are arranged in a tire circumferential direction in a land portion partitioned by a main groove extending in the tire circumferential direction, a depth of a transverse groove between the blocks adjacent in the tire circumferential direction ranges from 20% to 35%, inclusive, of a depth of the main groove, and a sipe narrower in width than the transverse groove is disposed on a bottom portion side of the transverse groove.

2. The pneumatic tire according to claim 1,
wherein an acute corner portion is formed on one side of the block in a tire width direction and an obtuse corner portion is formed on the other side of the block in the tire width direction by the transverse groove extending obliquely with respect to the tire width direction, and
wherein the sipe is inclined in a direction in which the sipe becomes farther from the acute corner portion on the acute corner portion side and inclined in a direction in which the sipe penetrates a lower part of the obtuse corner portion on the obtuse corner portion side as the sipe becomes deeper and twisted thereby.

3. The pneumatic tire according to claim 2,
wherein an inclination angle of the sipe with respect to a direction perpendicular to a ground contact surface increases as the sipe becomes closer to both sides in an extension direction of the transverse groove and the sipe and continuously changes from one end side to the other end side in the extension direction of the transverse groove and the sipe.

4. The pneumatic tire according to claim 2,
wherein an inclination angle of the sipe at a position where the sipe is most inclined with respect to a direction perpendicular to a ground contact surface is 15 degrees or less.

5. The pneumatic tire according to claim 1,
wherein the sipe is partially shallow.

6. The pneumatic tire according to claim 5,
wherein a middle part of the sipe in an extension direction is shallow.

7. The pneumatic tire according to claim 1,
wherein a narrow groove extending in the tire circumferential direction is disposed in the land portion partitioned by the main groove extending in the tire circumferential direction and a plurality of the transverse grooves in which the sipe is disposed on a groove bottom side is alternately disposed across the narrow groove.
